(19) United States
(12) Patent Application Publication
(10) Pub. No.: US 2011/0137514 A1
(43) Pub. Date: Jun. 9, 2011

(54) DRIVING FORCE CONTROLLING APPARATUS AND CONTROL METHOD OF DRIVING FORCE CONTROLLING APPARATUS

(75) Inventor: Kaiji Itabashi, Susono-shi (JP)

(73) Assignee: TOYOTA JIDOSHA KABUSHIKI KAISHA, Toyota-shi, Aichi (JP)

(21) Appl. No.: 13/058,042

(22) PCT Filed: Oct. 31, 2008
(86) PCT No.: PCT/JP2008/069965

§ 371 Date: Feb. 8, 2011

(51) Int. Cl. B60G 17/016; F02D 29/02; G06F 7/00

(52) U.S. Cl. 701/29; 701/37

(57) ABSTRACT

A driving force controlling apparatus includes a sprung vibration-damping control unit that suppresses a vibration, including a component in a pitch direction or a bounce direction, generated on a vehicle due to an input from a road surface to wheels by controlling a driving force of the vehicle. The change in the fuel injection amount by the sprung vibration-damping control unit is performed before the change in the fuel injection amount by a high-frequency vibration-damping control unit (jerk vibration-damping control unit, cylinder-to-cylinder correction control unit). The change in the fuel injection amount by the sprung vibration-damping control unit is performed after the change in the fuel injection amount by a vehicle behavior control unit (slowing-down control unit, assist control unit, brake control device). Accordingly, a vibration of a vehicle can effectively be suppressed.

### TECHNICAL FIELD

The present invention relates to a driving force controlling apparatus and a control method of a driving force controlling apparatus, and more particularly to a driving force controlling apparatus that performs a sprung vibration-damping control by a driving force generated by a driving source, and a control method of the driving force controlling apparatus.

### BACKGROUND ART

There has conventionally been known a vibration-damping control apparatus that executes a so-called sprung vibration-damping control for suppressing sprung vibration of a vehicle, as a vibration-damping control apparatus of a vehicle for suppressing vibration of a vehicle. The sprung vibration of a vehicle means vibration, among vibrations generated on a vehicle body through a suspension by the input from the road surface to the wheels of the vehicle with the road surface being defined as a vibration generating source, having a frequency component of 1 to 4 Hz (a frequency component that appears prominently is different depending upon a vehicle model or a structure of a vehicle, and in most vehicles, it is the frequency component near 1.5 Hz), wherein the sprung vibration of the vehicle includes components in the pitch direction or a bounce direction (vertical direction) of the vehicle. The sprung vibration-damping is to suppress the sprung vibration of the vehicle described above.

The Patent Document 1 has been proposed, for example, as a conventional vehicle vibration-damping control apparatus described above. The Patent Document 1 describes a vehicle stabilization control system in which a front-wheel-axle speed is calculated based upon a detection signal detected by a wheel speed sensor corresponding to a front wheel, a correction value for suppressing a pitching vibration is obtained from running resistance disturbance estimated based upon the calculated front-wheel-axle speed and a torque of a drive shaft estimated based upon a detection signal from an engine revolution speed sensor, and a basic required engine torque is corrected by the obtained correction value. In the vehicle stabilization control system, the pitching vibration can be suppressed, and the respective conditional amounts in the vehicle can be stabilized, whereby the running condition of the vehicle can be stabilized.
Patent Document 1: Japanese Patent Application Laid-open No. 2006-69472

### DISCLOSURE OF INVENTION

### Problem to be Solved by the Invention

In a driving force controlling apparatus, a control amount of a driving force is changed in the sprung vibration-damping control by a vehicle vibration-damping control apparatus described in the Patent Documents 1 and 2 described above. Here, the control amount of the driving force is changed for suppressing the vibration generated on the vehicle by an input from a vibration generating source, which is different from the vibration generating source for the sprung vibration, or changed for changing and controlling the behavior of the vehicle. The driving force control is executed based upon the changed control amount. However, the relationship between the change in the control amount by the sprung vibration-damping control and the change in the other control amounts has not yet been proposed, and therefore, it has been demanded that the respective vibration-damping controls for suppressing the vibration of the vehicle are effectively executed.

In view of this, the present invention aims to provide a driving force controlling apparatus that can effectively suppress the vibration of a vehicle, and a control method of the driving force controlling apparatus.

### Means for Solving Problem

In order to achieve the above mentioned object, in the present invention, a driving force controlling apparatus that controls a driving force generated by a driving source based upon a control amount, includes a sprung vibration-damping control unit that changes a control amount, which is calculated according to a requested value based upon at least either one of an accelerator operation by a driver and a running state of a vehicle, to a value by which the driving source can generate the driving force that suppresses a sprung vibration of the vehicle; and a high-frequency vibration-damping control unit that changes the control amount changed by the sprung vibration-damping control unit to a value by which the driving source can generate the driving force that suppresses a vibration having a frequency component higher than that of the sprung vibration of the vehicle suppressed by the sprung vibration-damping control unit, wherein the sprung vibration-damping control unit performs the change before the high-frequency component vibration-damping control unit changes the control amount.

Further, in the driving force controlling apparatus, it is preferable that the high-frequency vibration-damping control unit includes a first high-frequency vibration-damping control unit that suppresses a vibration generated on a power transmission path from the driving source to a driving wheel.

Further, in the driving force controlling apparatus, it is preferable that the high-frequency vibration-damping control unit includes a second high-frequency vibration-damping control unit that suppresses a vibration generated on the driving source.

Further, in the driving force controlling apparatus, it is preferable to further includes a vehicle behavior control unit that changes the control amount to a value by which the driving source can generate the driving force that changes the behavior of the vehicle for control, wherein the sprung vibration-damping control unit performs the change after the vehicle behavior control unit performs the change.

Further, in the driving force controlling apparatus, it is preferable that the vehicle behavior control unit includes a slowing-down control that regulates a slope of a change in the driving force.

Further, in the present invention, a driving force controlling apparatus that controls a driving force generated by a driving source, includes a sprung vibration-damping control unit that performs a change to the driving force to generate a wheel torque with a variation of the driving force, the wheel torque reducing the variation in the wheel speed generating a vibration of 1 to 4 Hz to the vehicle; and a high-frequency vibration-damping control unit that performs a change to the driving force to suppress a vibration that is generated on the vehicle and has a frequency component higher than 1 to 4 Hz, wherein the sprung vibration-damping control unit performs the change before the high-frequency vibration-damping control unit performs the change.

Further, in the present invention, a control method of a driving force controlling apparatus that controls a driving force generated by a driving source based upon a control amount, the method includes a step of changing a control amount, which is calculated according to a requested value based upon either one of an accelerator operation by a driver and a running state of a vehicle, to a value by which the driving source can generate the driving force that suppresses a sprung vibration of the vehicle; and a step of changing the changed control amount to a value by which the driving source can generate the driving force that suppresses a vibration having a frequency component higher than that of the sprung vibration of the vehicle.

### Effect of the Invention

According to the driving force controlling apparatus and the control method of the driving force controlling apparatus according to the present invention, the vibration of a vehicle can effectively be suppressed.

### BRIEF DESCRIPTION OF DRAWINGS

FIG. 1 is a diagram schematically illustrating a configuration of a vehicle having mounted thereto a driving force controlling apparatus according to an embodiment of the present invention.

FIG. 2 is a schematic diagram illustrating an example of an internal configuration of an electronic control unit including the driving force controlling apparatus according to the embodiment of the present invention.

FIG. 3 is a view for explaining a condition variable of a vibration of a vehicle body suppressed by a sprung vibration-damping control unit.

FIG. 4 is a schematic diagram illustrating an example of a functional configuration of the sprung vibration-damping control unit as a form of control blocks.

FIG. 5 is a view for explaining one example of a mechanical movement model of the vehicle-body vibration assumed at the sprung vibration-damping control unit.

FIG. 6 is a view for explaining one example of a mechanical movement model of the vehicle-body vibration assumed at the sprung vibration-damping control unit.

FIG. 7 is a view illustrating a relationship between a wheel-speed average and a time.

FIG. 8 is a view illustrating a relationship between a wheel-speed average and a time.

### EXPLANATIONS OF LETTERS OF NUMERALS

1 Driving force controlling apparatus
2 Brake control device
3 Automatic running control device
4 Injection amount calculating unit (control amount calculating unit)
4a Basic injection amount calculating unit
4b Adjusting unit
4c to 4h Injection amount changing unit
4i, 4k Input point
5 Sprung vibration-damping control unit
5a Feed-forward control unit
5b Feedback control unit
5c Wheel torque converting unit
5d Movement model unit
5e FF secondary regulator unit
5g FB secondary regulator unit
5f Wheel torque estimating unit
5h Adder
5i Injection amount converting unit
5k FF control correcting unit
5l FF control gain setting unit
5m FB control correcting unit
5n FB control gain setting unit
6 Jerk vibration-damping control unit
7 Cylinder-to-cylinder correction control unit
8 Slowing-down control unit
9 Assist control unit
10 Vehicle
20 Driving apparatus
21 Diesel engine (driving source)
22 MT
23 Differential gear unit
30FL, 30FR, 30RL, 30RR Wheel
40FL, 40FR, 40RL, 40RR Wheel speed sensor
50 Electronic control unit
60 Accelerator pedal
70 Pedal sensor
K·FF FF control gain
K·FB FB control gain
U·FF FF vibration-damping torque compensation amount (FF Control Amount)
U·FB FB vibration-damping torque compensation amount (FB control amount)

### BEST MODE(S) FOR CARRYING OUT THE INVENTION

The present invention will be described below in detail with reference to the drawings. It is to be noted that the present invention is not limited by the embodiments described below. The constituents in the embodiments described below include those that could easily be made by a person skilled in the art or those substantially equal. In the embodiment described below, a vehicle will be described that has mounted thereto only a diesel engine serving as a driving source for exerting a driving force on a vehicle, and having mounted thereto an MT that is a manual transmission as a transmission.

### Embodiment

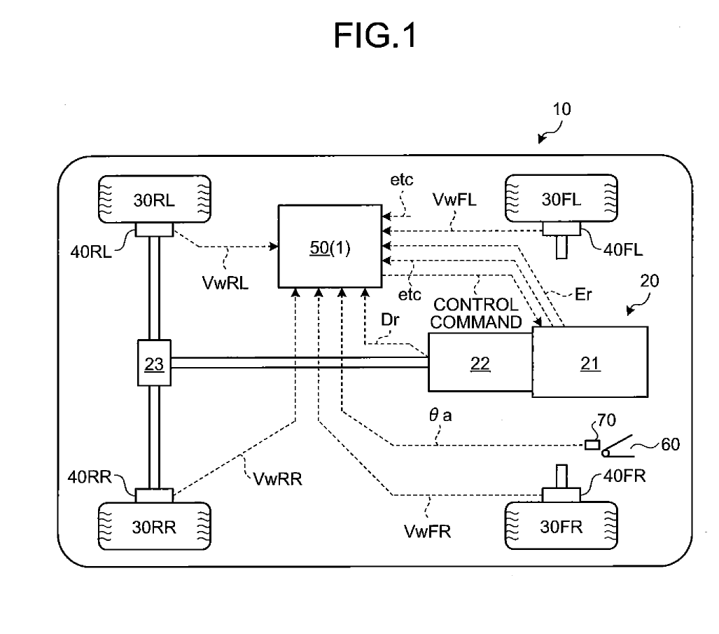

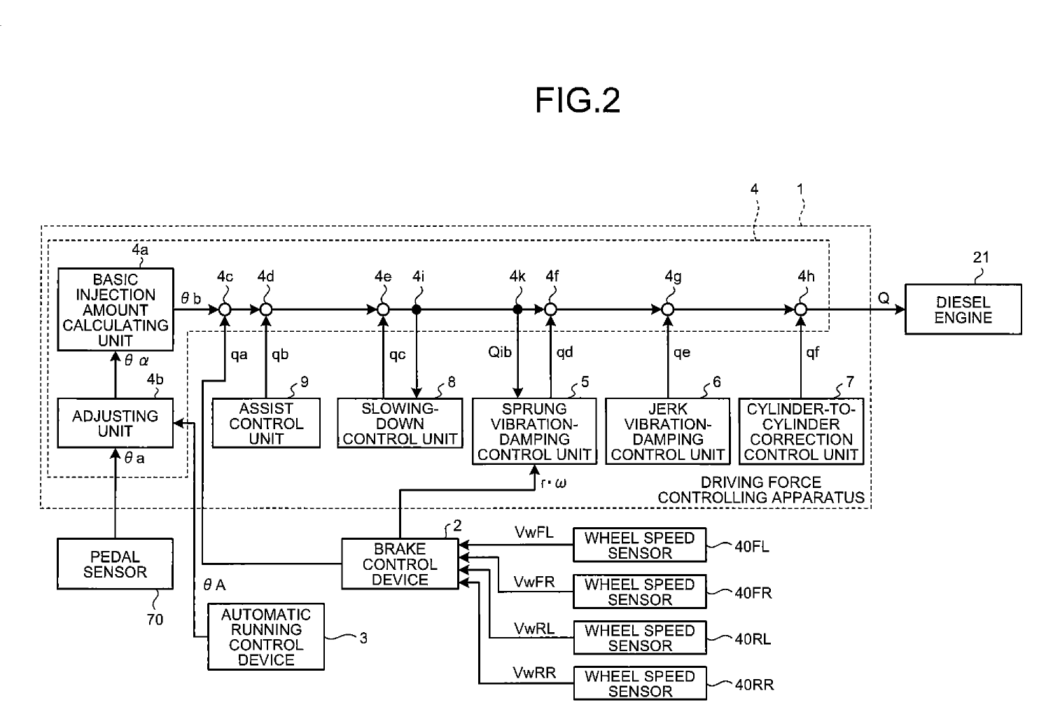

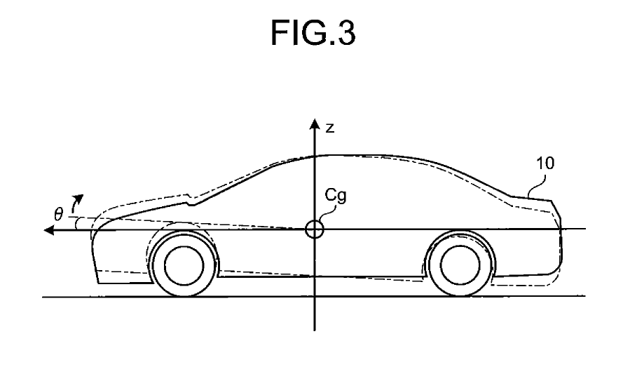

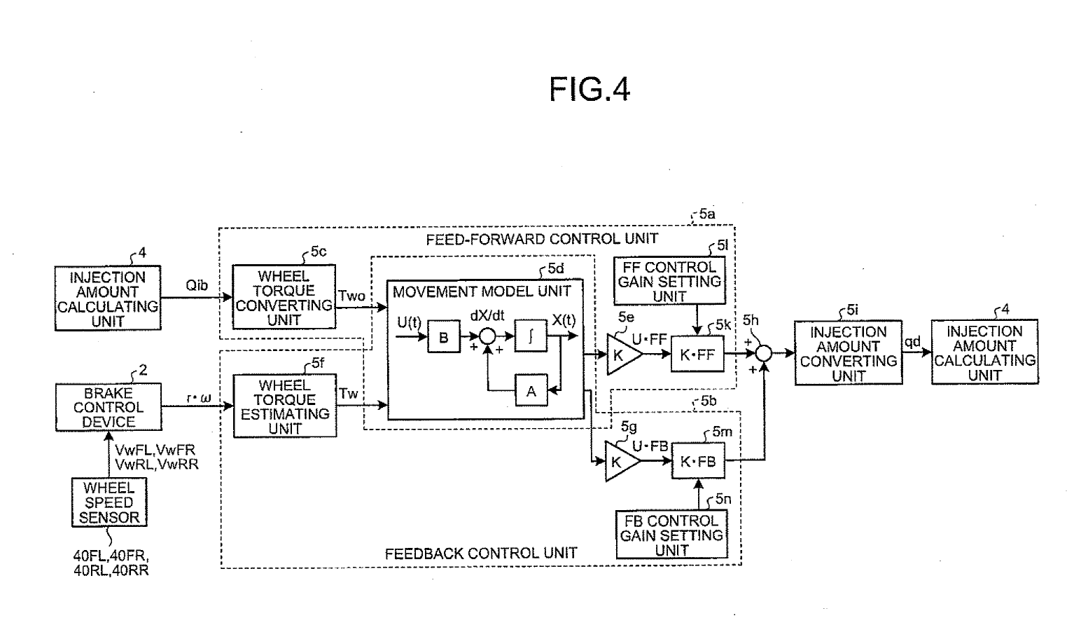

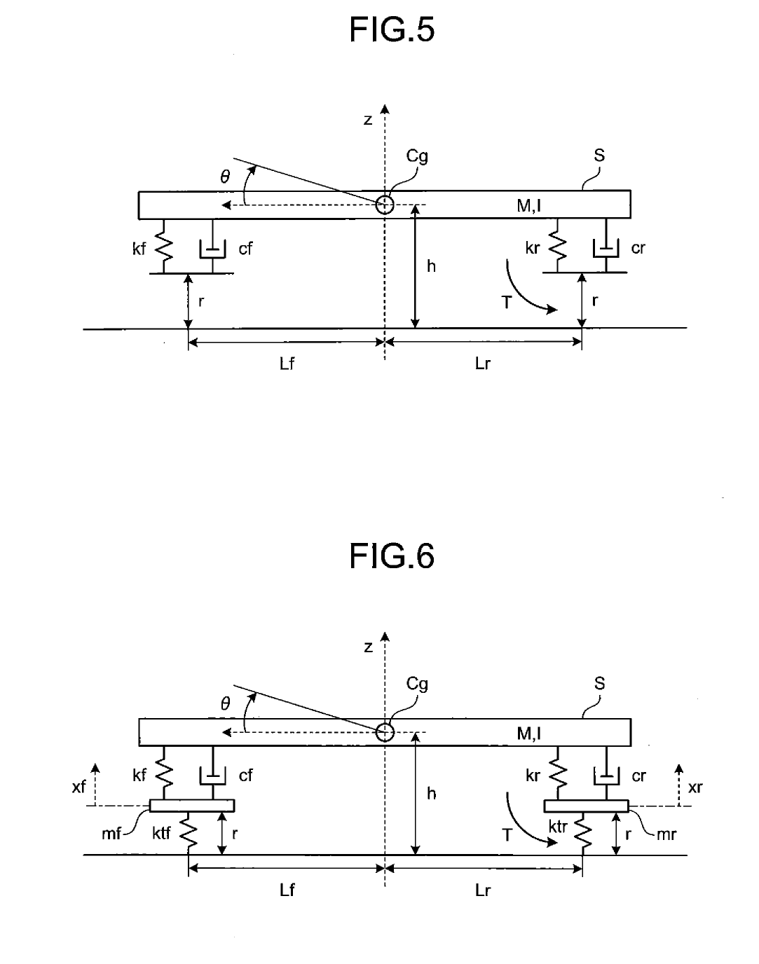

FIG. 1 is a diagram schematically illustrating a configuration of a vehicle having mounted thereto a driving force controlling apparatus according to an embodiment of the present invention. FIG. 2 is a schematic diagram illustrating an example of an internal configuration of an electronic control unit including the driving force controlling apparatus according to the embodiment of the present invention. FIG. 3 is a view for explaining a condition variable of a vibration of a vehicle body suppressed by a sprung vibration-damping control unit. FIG. 4 is a schematic diagram illustrating an example of a functional configuration of the sprung vibration-damping control unit as a form of control blocks. FIG. 5 is a view for explaining one example of a mechanical movement model of the vehicle-body vibration assumed at the sprung vibration-damping control unit. FIG. 6 is a view for explaining one example of a mechanical movement model of the vehicle-body vibration assumed at the sprung vibration-damping control unit.

A vehicle driving force controlling apparatus 1 according to the present embodiment is applied to a vehicle 10 having mounted thereto a diesel engine 21, serving as a driving source, as illustrated in FIG. 1. In the vehicle 10 having mounted thereto the driving force controlling apparatus 1 according to the present embodiment, the diesel engine 21 is mounted at the front part of the vehicle 10 in the forward advancing direction, wherein the vehicle 10 employs a rear wheel drive in which the driving wheels are wheels 30RL and 30RR that are left and right rear wheels. The position of the vehicle 10 where the diesel engine 21 is mounted is not limited to the front part. The diesel engine 21 may be mounted to a rear part or a middle part. The driving system of the vehicle 10 is not limited to the rear wheel drive, but may be a front wheel drive or four-wheel drive.

As illustrated in FIG. 1, the vehicle 10 to which the driving force controlling apparatus 1 is applied includes wheels 30FL and 30FR that are left and right front wheels, and wheels 30RL and 30RR that are left and right rear wheels. The vehicle 10 also includes an accelerator pedal 60 that is operated by a driver, and a pedal sensor 70 that detects a requested value by the driver's accelerating operation, i.e., an accelerator pedal depression amount θa that is a depression amount of the accelerator pedal 60, and outputs an electric signal corresponding to the accelerator pedal depression amount θa to the electronic control unit 50. The vehicle 10 is provided with a driving apparatus 20 that generates a driving force on the wheels 30RL and 30RR according to the driver's accelerating operation in various known manners. In the example illustrated in the figure, the driving apparatus 20 is configured such that the driving force (output torque) generated by the diesel engine 21 is transmitted to the wheels 30RL and 30RR through an MT 22, a differential gear unit 23 and the like. Although not illustrated, the vehicle 10 is provided with a braking device that generates braking force on the respective wheels and a steering apparatus that controls a steering angle of the front wheels or the front and rear wheels, as in the various known vehicles.

The electronic control unit 50, which also serves as the driving force controlling apparatus 1, controls the operation of the driving apparatus 20. The electronic control unit 50 may include, in a various known manners, a microcomputer having a CPU, a ROM, a RAM, and an input/output port, those of which are interconnected by a bi-directional common bus, and a drive circuit. A signal indicating a wheel speed Vwi (i=FL, FR, RL, RR) from the wheel speed sensor 40i (i=FL, FR, RL, RR) mounted to the wheels 30FL, 30FR, 30RL, and 30RR, and signals of an engine revolution speed (output revolution speed of the diesel engine 21) Er and an accelerator pedal depression amount θa from sensors mounted to the respective parts of the vehicle 10 are inputted to the electronic control unit 50. Various detection signals for acquiring various parameters required for various controls that should be executed in the vehicle 10 according to the present embodiment, e.g., signals of parameters (temperature of cooling water, temperature of intake air, pressure of intake air, atmospheric pressure, oil temperature, etc.) corresponding to the driving environment of the diesel engine 21, are also inputted to the electronic control unit 50, in addition to the signals described above.

As illustrated in FIG. 2, an electronic control unit (ECU) 40 is configured to include, for example, the driving force controlling apparatus 1 that controls the operation of the diesel engine 21, particularly the driving force generated by the diesel engine 21, based upon the control amount, that is a target fuel injection amount Q in the present embodiment, a brake control device 2 that controls the operation of a braking device not illustrated, and an automatic running control device 3 that automatically controls the running condition of the vehicle. The driving force controlling apparatus 1 is configured to be incorporated in the electronic control unit 50. Specifically, in the present embodiment, the driving force controlling apparatus 1 is configured by the electronic control unit 50 in the description. However, the invention is not limited thereto. The driving force controlling apparatus 1 and the electronic control unit 50 may be separately provided, wherein the driving force controlling apparatus 1 may be connected to the electronic control unit 50. The other control devices (brake control device 2, automatic running control device 3), other than the driving force controlling apparatus 1 may similarly be provided separately, wherein each control device may be connected to the electronic control unit 50.

As illustrated in FIG. 1, an electric signal in the form of a pulse, which is sequentially generated from the wheel speed sensors 40FL, 40FR, 40RL, and 40RR of the respective wheels 30FL, 30FR, 30RL, and 30RR every time the wheels rotate in a predetermined amount, is inputted to the brake control device 2. The brake control device 2 counts the time interval when the sequentially-inputted pulse signal reaches so as to calculate the rotation speed of the wheel, and calculates the wheel speed by multiplying the rotation speed by the radius of the wheel. The brake control device 2 outputs the average value r·ω of the wheel speeds VwFL, VwFR, VwRL, and VwRR corresponding respectively to the wheels 30FL, 30FR, 30RL, and 30RR to the driving force controlling apparatus 1 (in the present embodiment, a basic injection amount calculating unit 4a and a sprung vibration-damping control unit 5 of the driving force controlling apparatus 1) (the driving force controlling apparatus 1 may perform the calculation of the wheel speed from the rotation speed of the wheel. In this case, the rotation speed of the wheel is outputted from the brake control device 2 to the driving force controlling apparatus 1).

The brake control device 2 may be various known automatic brake control systems such as an ABS control, a VSC, or a TRC, i.e., may suppress that the friction force (the sum of vectors of the longitudinal force and the lateral force of the wheels 30FL, 30FR, 30RL, and 30RR) between the wheels 30FL, 30FR, 30RL, and 30RR and the road surface becomes excessive and exceeds a limit, or may control the longitudinal force or the slip ratio of the wheel in order to suppress the deterioration in the behavior of the vehicle 10, which is caused because the friction force of the wheels 30FL, 30FR, 30RL, and 30RR exceeds the limit. Alternatively, the brake control device 2 may be VDIM that stabilizes the behavior of the vehicle 10, including the steering control in addition to the slip-ratio control of the wheels 30FL, 30FR, 30RL, and 30RR in the ABS control, the VSC, or the TRC. When the VDIM is mounted, the brake control device 2 constitutes a part of the VDIM. The brake control device 2 may sometimes control the driving force generated by the diesel engine 21 in order to control to change the behavior of the vehicle 10, i.e., in order to positively control such that the behavior of the vehicle 10 is changed to attain the stable behavior, in the above-mentioned automatic brake controls (ABS control, VSC, TRC, VDIM). In the present embodiment, the brake control device 2 changes the target fuel injection amount Q, when executing the driving force control for changing and controlling the behavior of the vehicle 10 based upon the automatic brake control. Specifically, the brake control device 2 has also a function as a vehicle behavior control unit. When the brake control device 2 changes the target fuel injection amount Q based upon the automatic brake control, it outputs a brake control compensation amount qa, by which the driving force can change the behavior of the vehicle 10 to the stable behavior, to the driving force controlling apparatus 1 (in the present embodiment, an injection amount calculating unit 4), as illustrated in FIG. 2. The brake control compensation amount qa outputted from the brake control device 2 to the injection amount calculating unit 4 is inputted to the injection amount changing unit 4c, and added to or subtracted from the target fuel injection amount Q (the target fuel injection amount Q calculated at the basic injection amount calculating unit 4a) inputted to the injection amount changing unit 4c. As a result, the target fuel injection amount Q is changed in order to change and control the behavior of the vehicle 10 based upon the brake control compensation amount qa, whereby the control command according to the changed target fuel injection amount Q (the target fuel injection amount Q finally calculated by the injection amount calculating unit 4 based upon the target fuel injection amount Q that is changed based upon the brake control compensation amount qa) to the driving apparatus 20. The brake control device 2 may calculate an accelerator pedal depression amount, when it controls the driving force in order to change and control the behavior of the vehicle 10 based upon the automatic brake control. In this case, the calculated accelerator pedal depression amount is outputted to the driving force controlling apparatus 1 (in the present embodiment, an adjusting unit 4b).

The automatic running control device 3 performs an automatic running control such as a known CC (cruise control), i.e., controls the driving force generated by the diesel engine 21 in order that the vehicle 10 is in the running state, e.g., that the vehicle speed (the above-mentioned wheel speed) becomes constant. When the automatic running control device 3 executes the driving force control, it calculates the accelerator pedal depression amount θA in the automatic running control.

When the automatic running control device 3 calculates the accelerator pedal depression amount θA based upon the automatic brake control, it outputs the calculated accelerator pedal depression amount θA to the driving force controlling apparatus 1 (in the present embodiment, the adjusting unit 4b) as illustrated in FIG. 2.

The driving force controlling apparatus 1 controls the driving force generated by the diesel engine 21, serving as the driving source, based upon the target fuel injection amount Q that is the control amount. The driving force controlling apparatus 1 basically calculates the target fuel injection amount Q according to the accelerator pedal depression amount θα that is the requested value, and outputs the control command according to the target fuel injection amount Q to the diesel engine 21. The fuel in the target fuel injection amount Q is supplied to the diesel engine 21 based upon the control command, whereby the driving force corresponding to the supplied fuel is generated. The driving force controlling apparatus 1 is configured to include at least the injection amount calculating unit 4, the sprung vibration-damping control unit 5, a jerk vibration-damping control unit 6, a cylinder-to-cylinder correction control unit 7, a slowing-down control unit 8, and an assist control unit 9.

The injection amount calculating unit 4 is a control amount calculating unit, and calculates the target fuel injection amount Q, which is the control amount, according to the accelerator pedal depression amount θα that is the requested value based upon at least either one of the driver's accelerating operation and the running condition of the vehicle. Specifically, the injection amount calculating unit 4 calculates the target fuel injection amount Q according to the driving force requested to the diesel engine 21. The injection amount calculating unit 4 also changes the target fuel injection amount Q, which is calculated according to the accelerator pedal depression amount θα, based upon the later-described compensation amounts from the respective control units, so as to calculate the final target fuel injection amount Q. The injection amount calculating unit 4 is configured to include the basic injection amount calculating unit 4a, the adjusting unit 4b, the injection amount changing units 4c to 4h, and input points 4i and 4k.

The basic injection amount calculating unit 4a calculates the target fuel injection amount Q according to the accelerator pedal depression amount θα that is the requested value. The basic injection amount calculating unit 4a calculates the target fuel injection amount Q (the control amount according to the requested value), which becomes a reference, based upon the compensation amounts from the respective control units. The basic injection amount calculating unit 4a calculates the target fuel injection amount Q based upon the accelerator pedal depression amount θα outputted from the adjusting unit 4b and the vehicle speed V of the vehicle 10, i.e., the average value r·ω of the wheel speed outputted from the brake control device 2. Since the generated driving force is changed when the fuel injection amount is changed in the diesel engine 21, the calculated target fuel injection amount Q can be converted into the requested driving force generated by the diesel engine 21 according to the requested value.

When there are plural requested values, the adjusting unit 4b adjusts the plural requested values so as to output the accelerator pedal depression amount θα, which is the requested value, to the basic injection amount calculating unit 4a. In the present embodiment, the accelerator pedal depression amount θα that is the requested value by the driver's accelerating operation is inputted to the adjusting unit 4b from the pedal sensor 70. When the automatic running control of the vehicle 10 is performed, the accelerator pedal depression amount θA that is the requested value based upon the running condition of the vehicle 10 is inputted from the automatic running control device 3. When only the requested value by the accelerating operation is inputted, the adjusting unit 4b outputs the accelerator pedal depression amount θa to the basic injection amount calculating unit 4a, while when only the requested value based upon the running condition of the vehicle 10 is inputted, it outputs the accelerator pedal depression amount θA to the basic injection amount calculating unit 4a. When plural requested values are inputted, the adjusting unit 4b may output the maximum value of the inputted requested values to the basic injection amount calculating unit 4a, or may output the requested value according to the accelerating operation to the basic injection amount calculating unit 4a, regardless of the input of the requested value based upon the running condition of the vehicle 10. Specifically, the adjusting unit 4b outputs the requested value based upon at least either one of the driver's accelerating operation and the running condition of the vehicle to the basic injection amount calculating unit 4a.

The injection amount changing units 4c to 4h change the target fuel injection amount Q based upon the compensation amounts from the respective control units. In the present embodiment, the injection amount changing units 4c to 4h add or subtract the compensation amounts from the respective control units to or from the target fuel injection amount Q inputted to the injection amount changing units 4c to 4h, thereby changing the target fuel injection amount Q.

The injection amount changing unit 4c corresponds to the brake control device 2. It is provided between the basic injection amount calculating unit 4a and the injection amount changing unit 4f corresponding to the sprung vibration-damping control unit 5, i.e., is provided most closely to the basic injection amount calculating unit 4a (at the upstream side in the change of the target fuel injection amount Q). The injection amount changing unit 4c changes the target fuel injection amount Q calculated by the basic injection amount calculating unit 4a based upon the brake control compensation amount qa from the brake control device 2. Specifically, the change in the target fuel injection amount Q by the brake control device 2 is performed before the change in the target fuel injection amount Q by the sprung vibration-damping control unit 5.

The injection amount changing unit 4d corresponds to the assist control unit 9, and it is provided between the injection amount changing unit 4c corresponding to the brake control device 2 and the injection amount changing unit 4f corresponding to the sprung vibration-damping control unit 5. The injection amount changing unit 4d changes the target fuel injection amount Q changed by the brake control device 2 based upon an assist control compensation amount qb, described later, from the assist control unit 9. Specifically, the change in the target fuel injection amount Q by the assist control unit 9 is performed before the change in the target fuel injection amount Q by the sprung vibration-damping control unit 5.

The injection amount changing unit 4e corresponds to the slowing-down control unit 8, and it is provided between the injection amount changing unit 4d corresponding to the assist control unit 9 and the injection amount changing unit 4f corresponding to the sprung vibration-damping control unit 5. The injection amount changing unit 4e changes the target fuel injection amount Q changed by the assist control unit 9 based upon a slowing-down control compensation amount qc, described later, from the slowing-down control unit 8. Specifically, the change in the target fuel injection amount Q by the slowing-down control unit 8 is performed before the change in the target fuel injection amount Q by the sprung vibration-damping control unit 5.

The injection amount changing unit 4f corresponds to the sprung vibration-damping control unit 5, and it is provided between the injection amount changing unit 4e corresponding to the slowing-down control unit 8 and the injection amount changing unit 4g corresponding to the jerk vibration-damping control unit 6. The injection amount changing unit 4f changes the target fuel injection amount Q changed by the slowing-down control unit 8 based upon a sprung vibration-damping control compensation amount qd, described later, from the sprung vibration-damping control unit 5. Specifically, the change in the target fuel injection amount Q by the sprung vibration-damping control unit 5 is performed after the change in the target fuel injection amount Q by the brake control device 2, the change in the target fuel injection amount Q by the assist control unit 9, and the change in the target fuel injection amount Q by the slowing-down control unit 9, and before the change in the target fuel injection amount Q by the jerk vibration-damping control unit 6 and the change in the target fuel injection amount Q by the cylinder-to-cylinder correction control unit 7 described later.

The injection amount changing unit 4g corresponds to the jerk vibration-damping control unit 6, and it is provided between the injection amount changing unit 4f corresponding to the sprung vibration-damping control unit 5 and the injection amount changing unit 4h corresponding to the cylinder-to-cylinder correction control unit 7. The injection amount changing unit 4g changes the target fuel injection amount Q changed by the sprung vibration-damping control unit 5 based upon a jerk vibration-damping control compensation amount qe, described later, from the jerk vibration-damping control unit 6. Specifically, the change in the target fuel injection amount Q by the jerk vibration-damping control unit 6 is performed after the change in the target fuel injection amount Q by the sprung vibration-damping control unit 5.

The injection amount changing unit 4h corresponds to the cylinder-to-cylinder correction control unit 7, and it is provided at the rear of the injection amount changing unit 4g corresponding to the jerk vibration-damping control unit 6, i.e., provided closest to the diesel engine 21 (at the downstream side in the change of the target fuel injection amount Q). The injection amount changing unit 4h changes the target fuel injection amount Q changed by the jerk vibration-damping control unit 6 based upon a cylinder-to-cylinder correction control compensation amount qf, described later, from the cylinder-to-cylinder correction control unit 7. Specifically, the change in the target fuel injection amount Q by the cylinder-to-cylinder correction control unit 7 is performed after the change in the target fuel injection amount Q by the sprung vibration-damping control unit 5.

As described above, the injection amount calculating unit 4 calculates the final target fuel injection amount Q by sequentially changing the target fuel injection amount Q, which is calculated by the basic injection amount calculating unit 4a, by the respective control units in the present embodiment. Specifically, the injection amount calculating unit 4 calculates the final target fuel injection amount Q based upon the target fuel injection amount Q, which is changed based upon the respective compensation amounts.

The input point 4i is the position where the target fuel injection amount Q used in the slowing-down control unit 8 is inputted to the slowing-down control unit B. The input point 4i is formed between the injection amount changing unit 4e corresponding to the slowing-down control unit 8 and the injection amount changing unit 4f corresponding to the sprung vibration-damping control unit 5. Therefore, the target fuel injection amount Q changed by the slowing-down control unit 8 is inputted to the slowing-down control unit 8.

The input point 4k is the position where the target fuel injection amount Q used in the sprung vibration-damping control unit 5 is inputted to the sprung vibration-damping control unit 5. The input point 4k is formed between the injection amount changing unit 4e corresponding to the slowing-down control unit 8 and the injection amount changing unit 4f corresponding to the sprung vibration-damping control unit 5. Therefore, the target fuel injection amount Q, before it is changed by the sprung vibration-damping control unit 5 and which is changed by the respective control units that change the target fuel injection amount Q before the sprung vibration-damping control unit 5, is inputted to the sprung vibration-damping control unit 5. Specifically, the target fuel injection amount Qib, which is immediately before the change in the target fuel injection amount Q by the sprung vibration-damping control unit 5, is inputted to the sprung vibration-damping control unit 5.

The sprung vibration-damping control unit 5 executes a so-called sprung vibration-damping control for suppressing the sprung vibration of the vehicle 10. The sprung vibration of the vehicle 10 means vibration, among vibrations generated according to the irregularity on the road surface on the vehicle body of the vehicle 10 through a suspension by the input from the road surface to the wheels 30FL and 30FR, which are the left and right front wheels of the vehicle 10, and the wheels 30RL and 30RR, which are the left and right rear wheels of the vehicle 10, having a frequency component of 1 to 4 Hz, more specifically, the frequency component near 1.5 Hz, wherein the sprung vibration of the vehicle 10 includes components in the pitch direction or a bounce direction (vertical direction) of the vehicle. The sprung vibration vibration-damping is to suppress the sprung vibration of the vehicle 10 described above. When the vibration is generated in the pitch direction or a bounce direction (vertical direction) of the vehicle by the input from the road surface to the wheels 30FL and 30FR, which are the left and right front wheels of the vehicle 10, and the wheels 30RL and 30RR, which are the left and right rear wheels of the vehicle 10, which vibration has a frequency component of 1 to 4 Hz (a frequency component that appears prominently is different depending upon a vehicle model or a structure of a vehicle, and in most vehicles, it is the frequency component near 1.5 Hz), the sprung vibration-damping control unit 5 allows the diesel engine 21 to generate a driving force of a reverse phase, thereby adjusting the “wheel torque” (torque exerted between the wheel and the road surface with which the wheel is in contact) exerted by the wheel (the driving wheel upon the driving) to the road surface so as to suppress the vibration. Accordingly, a sprung vibration-damping control unit 12 of the vehicle 10 improves a driver's driving stability and ride comfort of occupants. According to the vibration-damping control by the driving force control described above, the source of the force that generates the vibration is adjusted to suppress the generation of the vibration energy, rather than the case in which the generated vibration energy is absorbed as in the vibration-damping control by the suspension, whereby the vibration-damping action can relatively promptly be executed, and the energy efficiency is excellent. In the vibration-damping control by the driving force control, the subject to be controlled is concentrated on the driving force (driving torque) of the driving source, so that the adjustment of the control is relatively easy.

In order to execute the sprung vibration-damping control by the driving force control, the sprung vibration-damping control unit 5 outputs to the driving apparatus 20 the control command according to the target fuel injection amount Q, which is obtained by changing the target fuel injection amount Q based upon the sprung vibration-damping control compensation amount qd (the target fuel injection amount Q finally calculated by the injection amount calculating unit 4 based upon the target fuel injection amount Q, which is changed based upon the sprung vibration-damping control compensation amount qd). The sprung vibration-damping control unit 5 performs (1) the acquisition of the wheel torque by the force exerted between the wheel and the road surface, (2) the acquisition of the pitch/bounce vibration state amount, and (3) the calculation of the compensation amount of the wheel torque suppressing the pitch/bounce vibration state amount and the change of the target fuel injection amount Q based upon the calculation. In the present embodiment, the wheel torque in (1) is set such that a wheel torque estimated value is calculated based upon the wheel speed (or the rotation speed of the wheel) received from the brake control device 2, but not limited thereto. As for the wheel torque, the wheel torque estimated value may be calculated based upon the engine revolution speed, or the wheel torque may be the detected value, detected by a sensor that can directly detect the wheel torque of the vehicle 10 that is running, e.g., a wheel torque sensor or a wheel six component force transducer, of the wheel torque actually generated on the wheel. The pitch/bounce vibration state amount in (2) is described as being calculated from a movement model of the vibration of the vehicle body of the vehicle 10, but not limited thereto. The pitch/bounce vibration state amount may be a detected value detected by various sensors such as a G sensor. The sprung vibration-damping control unit 5 is realized in the operation of the processes of (1) to (3).

When the driving apparatus 20 is operated based upon the driver's accelerating operation, i.e., the requested value corresponding to the driving request of the driver, so as to cause the variation in the wheel torque in the vehicle 10, for example, the bounce vibration (the vibration in the bounce direction) in the vertical direction (z direction) of the center of gravity Cg of the vehicle body and the pitch vibration (the vibration in the pitch direction) in the pitch direction (θ direction) about the center of gravity of the vehicle body can be generated on the vehicle body of the vehicle 10 illustrated in FIG. 3. When the external force or torque (disturbance) is exerted by the input to the wheels 30FL, 30FR, 30RL, and 30RR of the vehicle 10 from the road surface according to the irregularity of the road surface during the running of the vehicle 10, the disturbance is transmitted to the vehicle 10, resulting in that the pitch/bounce vibration can also be generated on the vehicle body. In view of this, the sprung vibration-damping control unit 5 constructs a movement model of the pitch/bounce vibration of the body of the vehicle 10, calculates displacements z, θ, and the rates of change dz/dt, dθ/dt, i.e., the state variables of the vibration of the vehicle body, when the target fuel injection amount Q that is the control amount according to the requested value (the value obtained by converting the target fuel injection amount Q into the wheel torque) and the current wheel torque (the estimated value of the current wheel torque) are inputted in this model, and adjusts the driving force of the diesel engine 21 in order that the state variables acquired from the model is converged to 0, i.e., in order to suppress the pitch/bounce vibration (specifically, the control amount is changed according to the requested value).

FIG. 4 is a schematic diagram schematically illustrating the configuration of the sprung vibration-damping control unit 5 as a form of control blocks (it is to be noted that the operation of each control block is basically executed by the driving force controlling apparatus 1 in the electronic control unit 50). As illustrated in FIG. 4, the sprung vibration-damping control unit 5 basically controls the driving force of the diesel engine 21 in the vehicle 10 in such a manner that the amplitude of the pitch/bounce vibration can be suppressed by supplying, to the diesel engine 21 in the vehicle 10, the fuel corresponding to the control command according to the target fuel injection amount Q that is changed based upon the sprung vibration-damping control compensation amount qd.

The sprung vibration-damping control unit 5 is configured to include a feed-forward control unit 5a, a feedback control unit 5b, an adder 5h, and an injection amount converting unit 5i.

The feed-forward control unit 5a has a structure of a so-called optimal regulator. Here, it is configured to include a wheel torque converting unit 5c, a movement model unit 5d, and an FF secondary regulator unit 5e. The feed-forward control unit 5a inputs the value obtained by converting the target fuel injection amount Qib (the target fuel injection amount Q that is before being changed by the sprung vibration-damping control unit 5 and that is changed by the respective control units changing the target fuel injection amount Q before the sprung vibration-damping control unit 5) by the wheel torque converting unit 5c (driver requested wheel torque Two) to the movement model unit 5d of the pitch/bounce vibration of the body of the vehicle 10. The movement model unit 5d calculates the response of the state variable of the vehicle 10 with respect to the inputted torque, and then, the FF secondary regulator unit 5e calculates, based upon a later-described predetermined gain K, an FF vibration-damping torque compensation amount U·FF as a correction amount of the driver requested wheel torque that converges the state variable to the minimum. The FF vibration-damping torque compensation amount U·FF is an FF control amount of the driving force at the feed-forward control unit 3a based upon the target fuel injection amount Q to the diesel engine 21.

The feedback control unit 5b has a structure of a so-called optimal regulator. Here, it is configured to include a wheel torque estimating unit 5f, a movement model unit 5d also serving as the feed-forward control unit 5a, and an FB secondary regulator unit 5g. The feedback control unit 5b calculates a wheel torque estimated value Tw based upon the average value r·ω of the wheel speed at the wheel torque estimating unit 5f as described later, wherein the wheel torque estimating value Tw is inputted to the movement model unit 5d as the input of the disturbance. Since the movement model unit of the feed-forward control unit 5a and the movement model unit of the feedback control unit 5b are the same, the movement model unit 5d is used for both units. However, the movement model unit 5d may be provided separately. The movement model unit 5d calculates the response of the state variable of the vehicle 10 with respect to the inputted torque, and then, the FB secondary regulator unit 5g calculates, based upon a later-described predetermined gain K, an FB vibration-damping torque compensation amount U·FB as a correction amount of the driver requested wheel torque that converges the state variable to the minimum. The FB vibration-damping torque compensation amount U·FB is an FB control amount of the driving force at the feedback control unit 5b according to the variation of the wheel speed based upon the external force or torque (disturbance) by the input to the wheels 30FL, 30FR, 30RL, and 30RR of the vehicle 10 from the road surface.

In the sprung vibration-damping control unit 5, the FF vibration-damping torque compensation amount U·FF that is the FF control amount of the feed-forward control unit 5a and the FB vibration-damping torque compensation amount U·FB that is the FB control amount of the feedback control unit 5b are outputted to the adder 5h. The FF vibration-damping torque compensation amount U·FF and the FB vibration-damping torque compensation amount U·FB are added at the adder 5h so as to calculate a vibration-damping control compensation wheel torque. The vibration-damping control compensation wheel torque is converted into the sprung vibration-damping control compensation amount qd, which is the value obtained by converting the vibration-damping control compensation wheel torque into the unit of the target fuel injection amount Q, at the injection amount converting unit 5i, whereby the converted sprung vibration-damping control compensation amount qd is outputted to the injection amount calculating unit 4. The sprung vibration-damping control compensation amount qd outputted to the injection amount calculating unit 4 from the sprung vibration-damping control unit 5 is inputted to the injection amount changing unit 4f, and is added or subtracted to or from the target fuel injection amount Qib (the target fuel injection amount Q that is changed by the addition or subtraction of the brake control compensation amount qa at the injection amount changing unit 4c, changed by the addition or subtraction of the assist control compensation amount qb at the injection amount changing unit 4d, and changed by the addition or subtraction of the slowing-down control compensation amount qc at the injection amount changing unit 4e) inputted to the injection amount changing unit 4f. As a result, the target fuel injection amount Q is changed so as not to generate the pitch/bounce vibration based upon the sprung vibration-damping control compensation amount qd, and the control command according to the changed target fuel injection amount Q is outputted to the driving apparatus 20. Specifically, the sprung vibration-damping control unit 5 changes the target fuel injection amount Q that is the control amount to the value by which the diesel engine 21 can generate the driving force for suppressing the sprung vibration of the vehicle 10.

Accordingly, the sprung vibration-damping control unit 5 can make a change in which the wheel torque that reduces the variation in the wheel speed generating the vibration of 1 to 4 Hz to the vehicle 10 is generated by the variation in the driving force with respect to the driving force generated by the diesel engine 21.

In the sprung vibration-damping control at the sprung vibration-damping control unit 5, a mechanical movement model in the pitch direction and the bounce direction of the body of the vehicle 10 is assumed as described above, and an equation of state of a state variable in the pitch direction or the bounce direction with the driver requested wheel torque Two, and the wheel torque estimated value Tw (disturbance) being defined as inputs is constructed. An input (torque value) that converges the state variable in the pitch direction and the bounce direction to 0 is determined from the equation of state with the use of the theory of the optimal regulator, whereby the target fuel injection amount Q that is the control value is changed based upon the obtained torque value.

As the mechanical movement model in the bounce direction or the pitch direction of the body of the vehicle 10, it is supposed, for example, that the vehicle body is regarded as a rigid body S of a mass M and an inertia moment I, and this rigid body S is supported by a front-wheel suspension having an elastic modulus Kf and an attenuation rate cf and a rear-wheel suspension having an elastic modulus Kr and an attenuation rate cr (sprung vibration model of the body of the vehicle 10), as illustrated in FIG. 5. In this case, an equation of motion in the bounce direction of the center of gravity of the vehicle body and an equation of motion in the pitch direction can be represented by a formula indicated by a formula 1 described below.

$$\begin{matrix}[ Formula 1 ] & \\ M \frac{{d}^{2} z}{d {t}^{2}} = - kf ( z + LF \cdot θ ) - cf ( \frac{d z}{d t} + Lf \cdot \frac{d θ}{d t} ) - kr ( z - Lr \cdot θ ) - cr ( \frac{d z}{d t} - Lr \cdot \frac{d θ}{d t} ) & ( 1 a ) \\ I \frac{{d}^{2} θ}{d {t}^{2}} = - Lf \{ kf ( z + Lf \cdot θ ) + cf ( \frac{d z}{d t} + Lf \cdot \frac{d θ}{d t} ) \} + Lr \{ kr ( z - Lr \cdot θ ) + cr ( \frac{d z}{d t} - Lr \cdot \frac{d θ}{d t} ) \} + \frac{h}{r} \cdot T & ( 1 b )\end{matrix}$$

In the formula 1, Lf and Lr indicates the distances from the center of gravity to the front-wheel axle and to the rear-wheel axle, r indicates the radius of the wheel, and h indicates the height of the center of gravity from the road surface. In the equation (1a), the first term and the second term are components of the force from the front-wheel axle, and the third and fourth terms are components of the force from the rear-wheel axle. In the equation (1b), the first term is the moment component of the force from the front-wheel axle, and the second term is the moment component of the force from the rear-wheel axle. The third term in the equation (1b) is the moment component of the force that the wheel torque T (Two, Tw) generated on the driving wheel applies around the center of gravity of the vehicle body.

The above-mentioned equations (1a) and (1b) can be rewritten to the form of the equation of state (of a linear system), as illustrated in the equation (2a) described below, wherein the displacements z, θ of the body of the vehicle 10, and the rates of change dz/dt, dθ/dt are defined as a state variable vector X(t).

dX(t)/dt=A·X(t)+B·u(t) (2a)

In the equation (2a), X(t), A, and B are

$$\begin{matrix}[ Formula 2 ] & \\ X ( t ) = ( \begin{matrix}z \\ d z / d t \\ θ \\ d θ / d t\end{matrix} ) , A = ( \begin{matrix}0 & 1 & 0 & 0 \\ a 1 & a 2 & a 3 & a 4 \\ 0 & 0 & 0 & 1 \\ b 1 & b 2 & b 3 & b 4\end{matrix} ) , B = ( \begin{matrix}0 \\ 0 \\ 0 \\ p 1\end{matrix} ) & \end{matrix}$$

wherein the respective elements a1 to a4 and b1 to b4 of the matrix A are given by combining the coefficients of z, θ, dz/dt, dθ/dt into the equations (1a) and (1b).

a1=−(kf+kr)/M,

a2=−(cf+cr)/M,

a3=−(kf·Lf−kr·Lr)/M,

a4=−(cf·Lf−cr·Lr)/M,

b1=−(Lf·kf−Lr·kr)/I,

b2=−(Lf·cf−Lr·cr)/I,

b3=−(Lf²·kf−Lr²·kr)/I,

b4=−(Lf²·cf+Lr²·cr)/I

Further, u(t) is

u(t)=T

wherein it is the input of the system represented by the equation of state (2a) described above. Accordingly, the element p1 of the matrix B is represented by p1=h/(I·r) from the equation (1b) described above.

In the equation of state (2a), when

u(t)=−K·X(t) (2b)

the equation of state (2a) becomes

dX(t)/dt=(A−BK)·X(t) (2c)

Accordingly, if X(t), i.e., the gain K that converges the displacement and the time rate of change in the bounce direction and the pitch direction to 0 is determined when the differential equation (2c) of the state variable vector X(t) is solved with the initial value X₀(t) of X(t) being set as X₀(t)=(0,0,0,0) (it is supposed that there is no vibration before the torque is inputted), the torque value u(t) for suppressing the bounce/pitch vibration is determined.

The gain K can be determined by using the theory of the optimal regulator. It has been known that, according to this theory, when the value of the quadratic evaluation function (the integration range is within 0 to ∞) such as

J=∫(X^{T}QX+u^{T}Ru)dt (3a)

becomes the minimum, the X(t) in the state of equation (2a) stably converges, wherein the matrix K that minimizes the evaluation function J is given by

K=R⁻¹·B^{T}·P

Here, P is the solution of the Riccati equation of

−dP/dt=A^{T}P+PA+Q−PBR⁻¹B^{T}P

The Riccati equation can be solved by an optional method known in a field of a linear system, whereby the gain K is determined.

The Q and R in the evaluation function J and the Riccati equation are a positive semidefinite symmetric matrix and a positive definite symmetric matrix that are optionally set, and they are weighting matrices of the evaluation function J determined by a designer of the system. For example, in the case of the movement model, the Q and R are set as

$$\begin{matrix}[ Formula 3 ] & \\ Q = ( \begin{matrix}1 & 0 & 0 & 0 \\ 0 & {10}^{3} & 0 & 0 \\ 0 & 0 & 1 & 0 \\ 0 & 0 & 0 & {10}^{2}\end{matrix} ) , R = ( 1 ) & \end{matrix}$$

and in the equation (3a), the norms (the magnitude of the norms) of the specific one of the components of the state vectors, e.g., the norm (magnitude) of the dz/dt, dθ/dt, is set greater than the norms of the other components, e.g., the norms of z, θ, the components to which the norms are set greater is more stably converged relatively. As the value of the component Q increases, the emphasis on the transient property, i.e., the value of the state vector, is promptly converged to the stabilized value, and as the value of R increases, the consumption energy is reduced. The gain K corresponding to the feed-forward control unit 5a and the gain K corresponding to the feedback control unit 5b may be different from each other. For example, the gain K corresponding to the feed-forward control unit 5a may be the gain with respect to the accelerating feeling of the driver, and the gain K corresponding to the feedback control unit 5b may be the gain with respect to the feedback or responsiveness of the driver.

In the actual sprung vibration-damping control in the sprung vibration-damping control unit 5, the differential equation (2a) is solved with the use of the torque inputted value, whereby the state variable vector X(t) is calculated in the movement model unit 5d as illustrated in block diagram in FIG. 4. Then, in the FF secondary regulator unit 5e and the FB secondary regulator unit 5g, the value u(t) obtained by multiplying the state vector X(t) that is the output from the movement model unit 5d by the gain K that is determined so as to converge the state variable vector X(t) to 0 or the minimum value, here, the FF vibration-damping torque compensation amount U·FF and the FB vibration-damping torque compensation amount U·FB, are converted into the unit of the fuel injection amount of the diesel engine 21, and subtracted from the target fuel injection amount Q at the injection amount changing unit 4f. The system represented by the equations (1a) and (1b) is the resonance system, wherein the value of the state variable vector is substantially only the component of a unique vibration frequency of the system with respect to the optional input. Accordingly, when it is configured that the u(t) (the converted value of u(t)) is subtracted from the target fuel injection amount Q, the component of the unique vibration frequency of the system, i.e., the component that causes the pitch/bounce vibration in the body of the vehicle 10, is corrected, whereby the pitch/bounce vibration in the body of the vehicle 10 is suppressed. When the component of the unique vibration frequency of the system is removed in the control amount (in the present embodiment, the target fuel injection amount Q) according to the requested value, the component of the unique vibration frequency of the system is only −u(t) among the control commands, according to the target fuel injection amount Q, outputted to the diesel engine 21, which means the vibration caused by Tw (disturbance) is converged.

As the mechanical movement model in the bounce direction and the pitch direction of the body of the vehicle 10, the model considering the spring elasticity of the tires of the front wheels and the rear wheels (the sprung and unsprung vibration models of the body of the vehicle 10) may be employed as illustrated in FIG. 6, in addition to the configuration in FIG. 5. As understood from FIG. 6, when it is supposed that the tires of the front wheels and the rear wheels have coefficients of elasticity ktf and ktr respectively, the equation of motion in the bounce direction of the center of gravity of the vehicle body and the equation of motion in the pitch direction can be represented by the equation indicated by a formula 4 described below.

$$\begin{matrix}[ Formula 4 ] & \\ M \frac{{d}^{2} z}{d {t}^{2}} = - kf ( z + Lf \cdot θ - xf ) - cf ( \frac{d z}{d t} + Lf \cdot \frac{d θ}{d t} - \frac{d xf}{d t} ) - kf ( z - Lf \cdot θ - xr ) - cr ( \frac{d z}{d t} - Lr \cdot \frac{d θ}{d t} - \frac{d xr}{d t} ) & ( 4 a ) \\ I \frac{{d}^{2} θ}{d {t}^{2}} = - Lf \{ kf ( z + Lf \cdot θ - xf ) + cf ( \frac{d z}{d t} + Lf \cdot \frac{d θ}{d t} - \frac{d xf}{d t} ) \} + Lr \{ kr ( z - Lr \cdot θ - xr ) + cr ( \frac{d z}{d t} - Lr \cdot \frac{d θ}{d t} - \frac{d xr}{d t} ) \} + \frac{b}{r} \cdot T & ( 4 b ) \\ mf \frac{{d}^{2} xf}{d {t}^{2}} = kf ( z + Lf \cdot θ - xf ) + cf ( \frac{d z}{d t} + Lf \cdot \frac{d θ}{d t} - \frac{d xf}{d t} ) + ktf \cdot xf & ( 4 c ) \\ mr \frac{{d}^{2} xr}{d {t}^{2}} = kr ( z - Lr \cdot θ - xr ) + cr ( \frac{d z}{d t} - Lr \cdot \frac{d θ}{d t} - \frac{d xr}{d t} ) + ktr \cdot xr & ( 4 d )\end{matrix}$$

In the formula 4, xf and xr are unsprung displacement amounts of the front wheels and the rear wheels, and mf and mr are unsprung masses of the front wheels and the rear wheels. The equation of (4a)-(4d) constructs the state of equation such as (2a) with z, θ, xf, xr, and their time-derivative values being defined as the state variable vectors, as in the case of FIG. 5 (the matrix A includes 8 rows and 8 columns, and the matrix B includes 8 rows and 1 column), whereby the gain matrix K that converges the magnitude of the state variable vector to 0 can be determined according to the theory of the optimal regulator. The actual vibration-damping control in the sprung vibration-damping control unit 12 is the same as that in FIG. 5.

The wheel torque inputted as the disturbance may be actually detected by providing torque sensors to the respective wheels 30FL, 30FR, 30RL, and 30RR in the feedback control unit 5b in the sprung vibration-damping control unit 5 in FIG. 4. Here, the wheel torque estimated value, which is estimated from the other values that can be detected at the running vehicle 10, at the wheel torque estimating unit 5f is used.

The wheel torque estimated value Tw can be estimated and calculated from the equation (5) described below by using the average value ω of the rotation speed of the wheel obtained from the wheel speed sensor corresponding to each wheel or the time-derivative value of the average r·ω of the wheel speed.

Tw=M·r²·dω/dt (5)

In the equation (5), M is a mass of the vehicle, and r is a radius of the wheel. Specifically, supposing that the total sum of the driving forces generated at the positions where the driving wheels are in contact with the road surface is equal to the total driving force M·G (G is the acceleration) of the vehicle 10, the wheel torque Tw can be given by the equation (5a) described below.

Tw=M·G·r (5a)

The acceleration G of the vehicle is obtained from the equation (5b) described below from the differential value of the wheel speed r·ω.

G=r·dω/dt (5b)

Accordingly, the wheel torque is estimated from the equation (5) described above.

The sprung vibration-damping control unit 5 in the present embodiment, which sets the vibration-damping control compensation torque based upon the FF vibration-damping torque compensation amount that is the FF control amount of the driving torque at the feed-forward control unit 5a based upon the control amount (target fuel injection amount Q) according to the requested value, and the FB vibration-damping torque compensation amount that is the FB control amount of the driving torque at the feedback control unit 5b based upon the wheel speed of the wheel of the vehicle 10, corrects the FF vibration-damping torque compensation amount or the FB vibration-damping torque compensation amount based upon the driving condition of the vehicle 10, thereby realizing the appropriate vibration-damping control according to the driving condition of the vehicle 10.

As described above, in the sprung vibration-damping control unit 5, the movement model unit 5d are used for both the feed-forward control unit 5a and the feedback control unit 5b, but basically, they are configured as the independent control systems. They respectively calculate the FF vibration-damping torque compensation amount and FB vibration-damping torque compensation amount, and then, adds the FF vibration-damping torque compensation amount and FB vibration-damping torque compensation amount so as to set the vibration-damping control compensation torque. Therefore, before actually setting the vibration-damping control compensation torque, the sprung vibration-damping control unit 5 can independently give upper and lower limit guards or make correction to the FF vibration-damping torque compensation amount at the feed-forward control unit 5a and the FB vibration-damping torque compensation amount at the feedback control unit 5b. With this process, either one of the control can easily be stopped according to the condition of the vehicle 10.

The sprung vibration-damping control unit 5 includes the feed-forward control unit 5a having an FF control correcting unit 5k and an FF control gain setting unit 5l, and the feedback control unit 5b having an FB control correcting unit 5m and an FB control gain setting unit 5n. The sprung vibration-damping control unit 5 corrects the FF vibration-damping torque compensation amount by the FF control correcting unit 5k and the FF control gain setting unit 5l, while corrects the FB vibration-damping torque compensation amount by the FB control correcting unit 5m and the FB control gain setting unit 5n. Specifically, the sprung vibration-damping control unit 5 sets the FF control gain to the FF vibration-damping torque compensation amount according to the condition of the vehicle 10, and multiplies the FF vibration-damping torque compensation amount by this FF control gain, thereby correcting the FF vibration-damping torque compensation amount. The sprung vibration-damping control unit 5 also sets the FB control gain to the FB vibration-damping torque compensation amount according to the condition of the vehicle 10, and multiplies the FB vibration-damping torque compensation amount by this FB control gain, thereby correcting the FB vibration-damping torque compensation amount.

The FF control correcting unit 5k is provided after the FF secondary regulator unit 5e, and before the adder 5h. The FF vibration-damping torque compensation amount U·FF is inputted to the FF control correcting unit 5k from the FF secondary regulator unit 5e, and it outputs the corrected FF vibration-damping torque compensation amount U·FF to the adder 5h. The FF control correcting unit 5k multiplies the FF vibration-damping torque compensation amount U·FF by the FF control gain K·FF, which is set by the FF control gain setting unit 5l, thereby correcting the FF vibration-damping torque compensation amount U·FF based upon the FF control gain K·FF. The FF control gain setting unit 5l sets the FF control gain K·FF according to the condition of the vehicle 10. Specifically, the FF vibration-damping torque compensation amount U·FF inputted from the FF secondary regulator unit 5e to the FF control correcting unit 5k is corrected by the FF control correcting unit 5k according to the vehicle 10, since the FF control gain K·FF is set by the FF control gain setting unit 5l according to the condition of the vehicle 10.

The FF control correcting unit 5k may set the upper and lower limit guards in order that the FF vibration-damping torque compensation amount U·FF falls within the upper and lower limit guards set beforehand. For example, the FF control correcting unit 5k may perform upper/lower limit guard, in which the value according to the allowable engine torque variation value, which is set beforehand to the FF vibration-damping torque compensation amount U·FF inputted from the FF secondary regulator unit 5e and that serves as the allowable driving force variation value of the diesel engine 21, is set as the upper and lower limit guard values (e.g., the value converted into a unit of the requested torque of the driving apparatus 20, and within minus several tens of Nm to 0 Nm), thereby correcting the FF vibration-damping torque compensation amount U·FF. Thus, the FF control correcting unit 5k can set the appropriate FF vibration-damping torque compensation amount U·FF considering the controls other than the sprung vibration-damping control by the sprung vibration-damping control unit 5. Specifically, the FF control correcting unit 5k can prevent the interference between the sprung vibration-damping control by the sprung vibration-damping control unit 5 and the other controls. The FF control correcting unit 5k may perform an upper limit guard, in which the value according to the allowable accelerating/decelerating speed of the vehicle 10 set beforehand to the FF vibration-damping torque compensation amount U·FF, which has not yet been outputted to the adder 5h, is set as the upper limit guard value (e.g., the value within the range less than the value corresponding to +0. 00G when converted into the accelerating/decelerating speed), thereby correcting the FF vibration-damping torque compensation amount U·FF. Thus, the FF control correcting unit 5k can set the appropriate FF vibration-damping torque compensation amount U·FF that can prevent that the change in the movement of the vehicle 10 greatly increases beyond the driver's expectation by the sprung vibration-damping control by the sprung vibration-damping control unit 5 for improving the driving stability of the driver and ride comfort of the occupants, and can prevent that the driver has a uncomfortable feeling.

The FB control correcting unit 5m is provided after the FB secondary regulator unit 5g, and before the adder 5h. The FB vibration-damping torque compensation amount U·FB is inputted to the FB control correcting unit 5m from the FB secondary regulator unit 5g, and it outputs the corrected FB vibration-damping torque compensation amount U·FB to the adder 5h. The FB control correcting unit 5m multiplies the FB vibration-damping torque compensation amount U·FB by the FB control gain K·FB, which is set by the FB control gain setting unit 5n, thereby correcting the FB vibration-damping torque compensation amount U·FB based upon the FB control gain K·FB. The FB control gain setting unit 5n sets the FB control gain K·FB according to the condition of the vehicle 10. Specifically, the FB vibration-damping torque compensation amount U·FB inputted from the FB secondary regulator unit 5g to the FB control correcting unit 5m is corrected by the FB control correcting unit 5m according to the vehicle 10, since the FB control gain K·FB is set by the FB control gain setting unit 5n according to the condition of the vehicle 10.

The FB control correcting unit 5m may set the upper and lower limit guards in order that the FB vibration-damping torque compensation amount U·FB falls within the upper and lower limit guards set beforehand. For example, the FB control correcting unit 5m may perform upper/lower limit guard, in which the value according to the allowable engine torque variation value, which is set beforehand to the FB vibration-damping torque compensation amount U·FB inputted from the FB secondary regulator unit 5g and that serves as the allowable driving force variation value of the diesel engine 21, is set as the upper and lower limit guard values (e.g., the value converted into a unit of the requested torque of the driving apparatus 20, and within ±several tens of Nm), thereby correcting the FB vibration-damping torque compensation amount U·FB. Thus, the FB control correcting unit 5m can set the appropriate FB vibration-damping torque compensation amount U·FB considering the controls other than the sprung vibration-damping control by the sprung vibration-damping control unit 5. Specifically, the FB control correcting unit 5m can prevent the interference between the sprung vibration-damping control by the sprung vibration-damping control unit 5 and the other controls. The FB control correcting unit 5m may perform an upper and lower limit guard, in which the value according to the allowable accelerating/decelerating speed of the vehicle 10 set beforehand to the FB vibration-damping torque compensation amount U·FB, which has not yet been outputted to the adder 5h, is set as the upper and lower limit guard values (e.g., the value within the range of the value corresponding to ±a/100G when converted into the accelerating/decelerating speed), thereby correcting the FB vibration-damping torque compensation amount U·FB. Thus, the FB control correcting unit 5m can set the appropriate FB vibration-damping torque compensation amount U·FB that can prevent that the change in the movement of the vehicle 10 greatly increases beyond the driver's expectation by the sprung vibration-damping control by the sprung vibration-damping control unit 12 for improving the driving stability of the driver and ride comfort of the occupants, and can prevent that the driver has a uncomfortable feeling.

The sprung vibration-damping control unit 5 in the present embodiment may correct the FF vibration-damping torque compensation amount and the FB vibration-damping torque compensation amount at the FF control correcting unit 5k and the FB control correcting unit 5m based upon the speed of the vehicle 10, the gear stages of the MT 22 mounted to the vehicle 10, if the MT 22 includes plural gear stages, the engine revolution speed as the output revolution of the diesel engine 21, and the requested torque, those of which serve as parameters indicating the condition of the vehicle 10. The sprung vibration-damping control unit 5 may correct the FB vibration-damping torque compensation amount based upon the driving state of the MT 22 mounted to the vehicle 10 by the FB control correcting unit 5m. The sprung vibration-damping control unit 5 may correct the FB vibration-damping torque compensation amount by the FB control correcting unit 5m based upon the allowable target fuel injection amount of the diesel engine 21. Specifically, the FF control gain setting unit 5l and the FB control gain setting unit 5n may set the FF control gain K·FF and the FB control gain K·FB based upon these factors.

In order to execute the jerk vibration-damping through the control of the driving force, the jerk vibration-damping control unit 6 outputs to the driving apparatus 20 the control command according to the target fuel injection amount Q, which is obtained by changing the target fuel injection amount Q based upon the jerk vibration-damping control compensation amount qe (the target fuel injection amount Q finally calculated by the injection amount calculating unit 4 based upon the target fuel injection amount Q, which is changed based upon the jerk vibration-damping control compensation amount qe). The jerk indicates the vibration generated on the power transmission path (the power transmission path of the driving force by the transmission mechanism of the driving force including the MT 22 and the differential gear unit 23) from the diesel engine 21 serving as the driving source to the driving wheels (in the present embodiment, the rear wheels), e.g., the vibration generated when the transmission mechanism is twisted in case where the driving force generated by the diesel engine 21 is transmitted to the driving wheel, and it is the vibration having a frequency component higher than 4 Hz and lower than 12 Hz. The jerk vibration-damping is to suppress the jerk of the vehicle 10 described above.

As illustrated in FIG. 2, the jerk vibration-damping control unit 6 calculates the jerk vibration-damping control compensation amount qe that changes the target fuel injection amount Q to the value, by which the diesel engine 21 can generate the driving force that suppresses the jerk of the vehicle 10, wherein the calculated jerk vibration-damping control compensation amount qe is outputted to the injection amount calculating unit 4. The jerk vibration-damping control compensation amount qe outputted to the injection amount calculating unit 4 from the jerk vibration-damping control unit 6 is inputted to the injection amount changing unit 4g, and added to or subtracted from the target fuel injection amount Q (the fuel injection amount Q that is changed through the addition or subtraction of the braking control compensation amount qa at the injection amount changing unit 4c, changed through the addition or subtraction of the assist control compensation amount qb at the injection amount changing unit 4d, changed through the addition or subtraction of the slowing-down control compensation amount qc at the injection amount changing unit 4e, and changed through the addition or subtraction of the sprung vibration-damping control compensation amount qd at the sprung vibration-damping control unit 5) inputted to the injection amount changing unit 4g. As a result, the target fuel injection amount Q is changed so as not to generate the jerk based upon the jerk vibration-damping control compensation amount qe, whereby the control command according to the target fuel injection amount Q (the target fuel injection amount Q finally calculated by the injection amount calculating unit 4 based upon the target fuel injection amount Q that is changed based upon the jerk vibration-damping control compensation amount qe) is outputted to the driving apparatus 20. Specifically, the jerk vibration-damping control unit 6 changes the target fuel injection amount Q serving as the control amount to the value by which the diesel engine 21 can generate the driving force suppressing the jerk of the vehicle 10. Accordingly, the jerk vibration-damping control unit 6 is a high-frequency vibration-damping control unit that changes the target fuel injection amount Q to the value, by which the diesel engine 21 can generate the driving force that suppresses the vibration having a frequency component higher than that of the sprung vibration of the vehicle 10 suppressed by the sprung vibration-damping control unit 5, and the jerk vibration-damping control unit is a first high-frequency vibration-damping control unit that suppresses the vibration generated on the power transmission path from the driving source to the driving wheel. Accordingly, since the jerk vibration-damping control unit 6 changes the driving force generated by the diesel engine 21, it reduces the wheel torque, which reduces the variation in the wheel speed generating the vibration of the frequency component higher than 1 to 4 Hz generated on the vehicle 10, with the variation in the driving force. The jerk vibration-damping control has already been known, and the known method can be used for the calculating method of the jerk vibration-damping control compensation amount qe, so that the detail of the calculating method will be skipped.

The cylinder-to-cylinder correction control unit 7 performs the cylinder-to-cylinder correction control for suppressing the variation in each cylinder of the diesel engine 21. The variation of each cylinder means the variation in the injector provided to each cylinder of the diesel engine 21, for example. When there is the variation in each cylinder, the variation is caused in the fuel supplied to each cylinder, whereby the explosion force in each cylinder varies due to the variation in the supplied fuel, with the result that the vibration is caused on the vehicle 10. Specifically, the cylinder-to-cylinder correction control unit 7 suppresses the vibration generated on the diesel engine 21 serving as the driving source. In order to execute the brake vibration-damping due to the variation in the respective cylinders, the cylinder-to-cylinder correction control unit 7 outputs to the driving apparatus 20 the control command according to the target fuel injection amount Q, which is obtained by changing the target fuel injection amount Q based upon the cylinder-to-cylinder correction control compensation amount qf (the target fuel injection amount Q finally calculated by the injection amount calculating unit 4 based upon the target fuel injection amount Q that is changed based upon the cylinder-to-cylinder correction control compensation amount qf).

As illustrated in FIG. 2, the cylinder-to-cylinder correction control unit 7 calculates the cylinder-to-cylinder correction control compensation amount qf, which changes the target fuel injection amount Q to the value by which the diesel engine 21 can generate the driving force that suppresses the variation in the respective cylinders of the vehicle 10 (the value which can equalize the explosion force in the respective cylinders), and the calculated cylinder-to-cylinder correction control compensation amount qf is outputted to the injection amount calculating unit 4. The cylinder-to-cylinder correction control compensation amount qf outputted from the cylinder-to-cylinder correction control unit 7 to the injection amount calculating unit 4 is inputted to the injection amount changing unit 4h, and is added to or subtracted from the target fuel injection amount Q inputted to the injection amount changing unit 4h (the target fuel injection amount Q that is changed through the addition or subtraction of the braking control compensation amount qa at the injection amount changing unit 4c, changed through the addition or subtraction of the assist control compensation amount qb at the injection amount changing unit 4d, changed through the addition or subtraction of the slowing-down control compensation amount qc at the injection amount changing unit 4e, changed through the addition or subtraction of the sprung vibration-damping control compensation amount qd at the sprung vibration-damping control unit 5, and changed through the addition or subtraction of the jerk vibration-damping control compensation amount qe at the jerk vibration-damping control unit 6). As a result, the target fuel injection amount Q is changed so as not to generate the vibration due to the variation in the respective cylinders based upon the cylinder-to-cylinder correction control compensation amount qf, and the control command according to the changed target fuel injection amount Q (the target fuel injection amount Q finally calculated by the injection amount calculating unit 4 based upon the target fuel injection amount Q, which is changed based upon the cylinder-to-cylinder correction control compensation amount qf) is outputted to the driving apparatus 20. Specifically, the cylinder-to-cylinder correction control unit 7 changes the target fuel injection amount Q serving as the control amount to the value by which the diesel engine 21 can generate the driving force suppressing the vibration caused by the variation in the respective cylinders of the vehicle 10. Accordingly, the cylinder-to-cylinder correction control unit 7 is a high-frequency vibration-damping control unit that changes the target fuel injection amount Q to the value, by which the diesel engine 21 can generate the driving force that suppresses the vibration having a frequency component higher than that of the sprung vibration of the vehicle 10 suppressed by the sprung vibration-damping control unit 5, and the cylinder-to-cylinder correction control unit 7 is a second high-frequency vibration-damping control unit that suppresses the vibration generated on the driving source. Accordingly, the cylinder-to-cylinder correction control unit 7 can make a change in which the wheel torque that reduces the variation in the wheel speed generating the vibration generated on the vehicle 10 and having a frequency component higher than 1 to 4 Hz is generated by the variation in the driving force with respect to the driving force generated by the diesel engine 21. The cylinder-to-cylinder correction control has already been known, and the known method can be used for the calculating method of the cylinder-to-cylinder correction control compensation amount qf, so that the detail of the calculating method will be skipped.

The slowing-down control unit 8 is a vehicle behavior control unit that performs a slowing-down control for regulating a slope of the change in the driving force. For example, when the accelerator pedal depression amount θa is sharply changed (is changed in a form of a pulse) due to the accelerating operation by a driver, the target fuel injection amount Q that is the control amount is sharply changed, so that the driving force generated by the diesel engine 21 sharply changes. Therefore, the vehicle 10 greatly varies in at least the pitch direction. Accordingly, the slowing-down control unit 8 regulates the slope of the change in the driving force in order to control through the change in the behavior of the vehicle 10, i.e., in order to positively control such that the vehicle 10 does not greatly vary in at least the pitch direction through the change in the behavior of the vehicle 10. Specifically, the slowing-down control unit 8 changes the target fuel injection amount Q to the value that the diesel engine 21 generates the driving force for making a control by changing the behavior of the vehicle 10. The slowing-down control unit 8 performs a feedback control of the target fuel injection amount Q based upon the target fuel injection amount Q inputted at the input point 4i.

As illustrated in FIG. 2, the slowing-down control unit 8 calculates a slowing-down control compensation amount qc, by which the driving force can change the behavior of the vehicle 10 so as to prevent the vehicle 10 from greatly varying in at least the pitch direction, and the calculated slowing-down control compensation amount qc is outputted to the injection amount calculating unit 4. The slowing-down control compensation amount qc outputted to the injection amount calculating unit 4 from the slowing-down control unit 8 is inputted to the injection amount changing unit 4e, added to or subtracted from the target fuel injection amount Q inputted to the injection amount changing unit 4e (the fuel injection amount Q that is changed through the addition or subtraction of the braking control compensation amount qa at the injection amount changing unit 4c, and changed through the addition or subtraction of the assist control compensation amount qb at the injection amount changing unit 4d). As a result, the target fuel injection amount Q is changed so as to control to change the behavior of the vehicle 10 based upon the slowing-down control compensation amount qc, and the control command according to the changed target fuel injection amount Q (the target fuel injection amount Q finally calculated by the injection amount calculating unit 4 based upon the target fuel injection amount Q, which is changed based upon the slowing-down control compensation amount qc) is outputted to the driving apparatus 20. The slowing-down control has already been known, and the known method can be used for the calculating method of the slowing-down control compensation amount qc, so that the detail of the calculating method will be skipped.

The assist control unit 9 is a vehicle behavior control unit that performs the assist control in which the driving force generated by the diesel engine 21 is increased so as to assist the driver upon the start of the vehicle 10. Since the vehicle 10 according to the present embodiment includes the MT 22, the driver depresses the accelerator pedal so as to engage the clutch not illustrated, whereby the diesel engine 21 and the MT 22 are connected, upon the start. However, there may be the case in which the driving force, which is generated by the diesel engine 21 based upon the target fuel injection amount Q that is the control amount according to the accelerator pedal depression amount θa by the driver's accelerating operation, is insufficient. When the driving force generated by the diesel engine 21 upon the start is insufficient, the vehicle 10 greatly changes in at least the pitch direction. Accordingly, the assist control unit 9 greatly increases the driving force generated by the diesel engine 21 in order to control to change the behavior of the vehicle 10, i.e., in order to positively control to prevent the vehicle 10 upon the start from greatly changing in at least the pitch direction by changing the behavior of the vehicle 10. Specifically, the assist control unit 9 changes the target fuel injection amount Q to the value that the diesel engine 21 generates the driving force for making a control by changing the behavior of the vehicle 10.

As illustrated in FIG. 2, the assist control unit 9 calculates an assist control compensation amount qb, by which the driving force can change the behavior of the vehicle 10 so as to prevent the vehicle 10 from greatly varying in at least the pitch direction upon the start, and the calculated assist control compensation amount qb is outputted to the injection amount calculating unit 4. The assist control compensation amount qb outputted to the injection amount calculating unit 4 from the assist control unit 9 is inputted to the injection amount changing unit 4d, and added to or subtracted from the target fuel injection amount Q inputted to the injection amount changing unit 4d (the fuel injection amount Q that is changed through the addition or subtraction of the braking control compensation amount qa at the injection amount changing unit 4c). As a result, the target fuel injection amount Q is changed so as to control to change the behavior of the vehicle 10 based upon the assist control compensation amount qb, and the control command according to the changed target fuel injection amount Q (the target fuel injection amount Q finally calculated by the injection amount calculating unit 4 based upon the target fuel injection amount Q, which is changed based upon the assist control compensation amount qb) is outputted to the driving apparatus 20.

As described above, according to the driving force controlling apparatus 1 in the present embodiment, the change in the target fuel injection amount Q by the sprung vibration-damping control unit 5 is executed before the change in the target fuel injection amount Q by the jerk vibration-damping control unit 6 and the change in the target fuel injection amount Q by the cylinder-to-cylinder correction control unit 7. Specifically, the vibration-damping control in which the vibration having a frequency component higher than the sprung vibration, which is suppressed by the sprung vibration-damping control unit 5, is suppressed by the high-frequency vibration-damping control unit is executed after the vibration-damping control by the sprung vibration-damping control unit 5. Accordingly, the vibration-damping control for the vibration having the frequency component higher than that of the sprung vibration is executed after the vibration-damping control for the sprung vibration, which can prevent that the vibration-damping control for the sprung vibration is executed based upon the target fuel injection amount Q that is changed based upon the vibration-damping control for the vibration having the frequency component higher than that of the sprung vibration.

Consequently, the vibration-damping control for suppressing the vibration having the frequency component higher than that of the sprung vibration, which is suppressed by the sprung vibration-damping control unit 5, can effectively be performed, compared to the case in which the sprung vibration-damping control is executed after the vibration-damping control that suppresses the vibration having the frequency component higher than that of the sprung vibration, which is suppressed by the sprung vibration-damping control unit 5. The change in the target fuel injection amount Q by the sprung vibration-damping control unit 5 is executed after the change in the target fuel injection amount Q by the slowing-down control unit 8, the change in the target fuel injection amount Q by the assist control unit 9, and the change in the target fuel injection amount Q by the brake control device 2. Specifically, the control for changing the behavior of the vehicle 10 by the vehicle behavior control unit is executed before the vibration-damping control by the sprung vibration-damping control unit 5. Therefore, since the control for changing the behavior of the vehicle 10 is performed before the vibration-damping control by the sprung vibration-damping control unit 5, it can be prevented that the control for changing the behavior of the vehicle 10 is executed based upon the target fuel injection amount Q, which is changed based upon the vibration-damping control for the sprung vibration. Thus, the sprung vibration-damping control can effectively be executed, compared to the case in which the control for changing the behavior of the vehicle 10 is performed after the execution of the sprung vibration-damping control. Accordingly, the vibration of the vehicle 10 can effectively be suppressed.

The driving force controlling apparatus 1 according to the above-mentioned embodiment is not limited to the embodiment described above, but various modifications are possible without departing from the scope described in the claims.

In the above-mentioned embodiment, the sprung vibration-damping control is explained by utilizing the theory of the optimal regulator, with the sprung movement model or the sprung/unsprung movement model being supposed as the movement model. However, the invention is not limited thereto. The present invention may be applied to the one employing the movement model other than that described above, or the one employing the control method other than the optimal regulator.

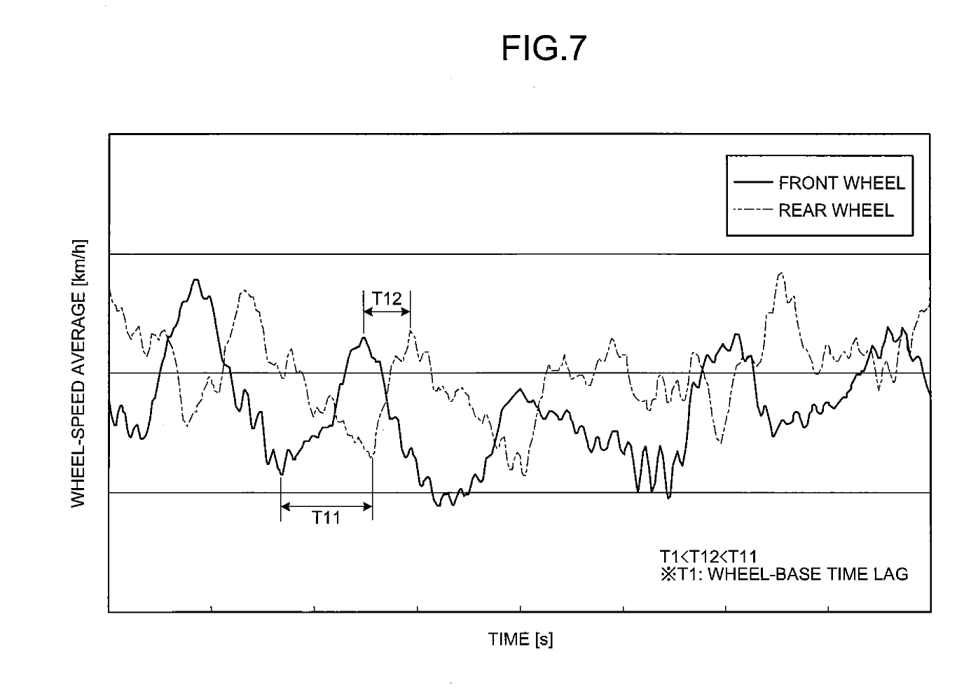

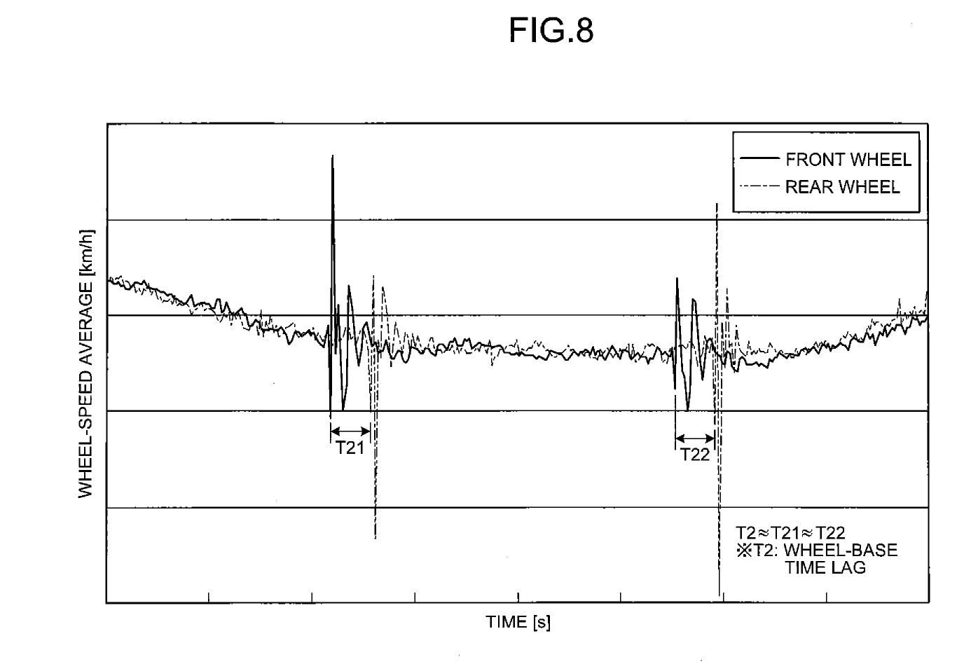

Although the average value r·ω of the wheel speeds from the wheel speed sensors 40FL, 40FR, 40RL, and 40RR corresponding to all of four wheels is set as the input value to the feedback control unit 5b in the sprung vibration-damping control unit 5 in the above-mentioned embodiment, the present invention is not limited thereto. It is preferable that the average value r·ω of only the wheel speeds from the wheel speed sensors 40FL and 40FR corresponding to the front wheels is set as the input value. FIG. 7 is a view illustrating a relationship between a wheel-speed average and a time. FIG. 8 is a view illustrating a relationship between a wheel-speed average and a time. In FIGS. 7 and 8, a solid line indicates a wheel-speed average that is the average value of only the wheel speeds from the wheel speed sensors 40FL and 40FR corresponding to the front wheels, while a chain line indicates a wheel-speed average that is the average value of only the wheel speeds from the wheel speed sensors 40RL and 40RR corresponding to the rear wheels. FIGS. 7 and 8 illustrate the result in which the vehicles having the same wheel base run. FIG. 7 illustrates the result in which the vehicle runs on a road surface having irregularities of about 20 cm that appear repeatedly, i.e., on a road surface where the sprung vibration described above significantly occurs on the vehicle, while FIG. 8 illustrates the result in which the vehicle runs on a road surface having two steps. In FIG. 7, a wheel-base time lag, which is a time lag of the wheel-speed average of the rear wheels to the wheel-speed average of the front wheels by a vehicle wheel base is defined as T1, while in FIG. 8, a wheel-base time lag, which is a time lag of the wheel-speed average of the rear wheels to the wheel-speed average of the front wheels by a vehicle wheel base is defined as T2.

As illustrated in FIG. 8, when the vehicle passes through the step, the wheel-speed average of the front wheels and the wheel-speed average of the rear wheels are greatly changed. During the period from when the front wheels pass through the step to when the rear wheels pass through the step, the time lag from when the wheel-speed average of the front wheels greatly changes to when the wheel-speed average of the rear wheels greatly changes is generated. When the time lag which is the period from when the front wheels pass through the first step to when the rear wheels pass through the first step is defined as T21, and the time lag which is the period from when the front wheels pass through the second step to when the rear wheels pass through the second step is defined as T22, T21 and T22 are substantially the same as illustrated in the figures, and are substantially equal to the wheel base time lag T2 (T2≈C21≈T22). Specifically, there is no chance that the input of the signals from the wheel speed sensors 40FL and 40FR corresponding to the front wheels and from the wheel speed sensors 40RL and 40RR corresponding to the rear wheels to the electronic control unit 50 is delayed, when the vehicle runs on a road surface where the vehicle generally runs.

On the other hand, as illustrated in FIG. 7, when a time lag from when the front wheels pass through an optional point to when the rear wheels pass through the same point is defined as T11, and the time lag from when the front wheels pass through the other optional point to when the rear wheels pass through the same other point is defined as T12 in case where the vehicle runs on the road surface where the sprung vibration significantly occurs on the vehicle, T11 and T12 are different from each other, and are greater than the wheel base time lag T1 (T1<T12<T11) as illustrated in the figure. Specifically, when the vehicle runs on the road surface where the sprung vibration, i.e., the vibration having the frequency component of 1 to 4 Hz, more specifically, near 1.5 Hz, significantly occurs, the input of the signals from the wheel speed sensors 40RL and 40RR corresponding to the rear wheels to the electronic control unit 50 is delayed more than the signals from the wheel speed sensors 40FL and 40FR corresponding to the front wheels.

As described above, since the average value r·ω of only the wheel speeds from the wheel speed sensors 40FL and 40FR corresponding to the front wheels is set as the input value of the feedback control unit 5b in the sprung vibration-damping control unit 5, the responsiveness of the sprung vibration-damping control can be enhanced more than in the case where the average value r·ω of only the wheel speeds from the wheel speed sensors 40RL and 40RR corresponding to the rear wheels is set as the input value.

Although the diesel engine is employed as the driving source in the present embodiment described above, the present invention is not limited thereto. The driving source may be a gasoline engine or a motor. When the gasoline engine is mounted, a requested driving force is calculated as the control amount, and a target throttle angle or a target ignition time based upon the requested driving force is outputted to the gasoline engine as the control command, whereby the driving force (output torque) generated by the gasoline engine is controlled. When the motor is mounted, a target current amount is calculated as the control amount, and a control command according to the target current amount is outputted to the motor, whereby the driving force (motor torque) generated by the motor is controlled. The vehicle may be the one employing only the gasoline engine as the driving source, the one employing only the motor as the driving source, or may be a hybrid vehicle employing an engine and a motor as the driving source.

When the requested driving force is used as the control amount, the automatic running control device 3 may calculate the requested driving force when it executes the driving force control in the automatic running control. In this case, the requested driving force may be calculated as the control amount based upon the accelerator pedal depression amount θa that is the requested value according to the driver's accelerating operation, and a requested driving force (the control amount according to the requested value), which becomes a reference, may be calculated through the adjustment to the requested driving force corresponding to the automatic running control described above.

Although the MT 22 is mounted as a transmission in the above-mentioned embodiment, the present invention is not limited thereto. An AT that is a stepped automatic transmission may be mounted as a transmission, for example. In this case, a creep assist control unit may be provided as a vehicle behavior control unit. The creep assist control is a control for changing the driving force generated by the driving source according to the slope of the road surface, for example, so as to change the behavior of the vehicle 10 during when the vehicle stops or when the vehicle runs with a low speed. The change in the control amount by the creep assist control is executed before the change in the control amount by the sprung vibration-damping control unit.

When the AT is mounted as a transmission, the automatic running control device 3 may perform an automatic running control such as ACC (adaptive cruise control) for controlling the driving force generated by the driving source in order to make the vehicle speed (the above-mentioned wheel speed) or the distance between the vehicle and a leading vehicle constant.

When an electronic control AT (ECT) in which the shift is performed by an electronic control is mounted as a transmission, an ECT control unit may be provided as the vehicle behavior control unit. The ECT control is a control for changing the driving force generated by the driving source during the shift by the AT so as to change the behavior of the vehicle 10 during the shift. The change in the control amount by the ECT control unit is performed before the change in the control amount by the sprung vibration-damping control unit.

Although not described in the above-mentioned embodiment, the change based upon parameters (temperature of cooling water, temperature of intake air, pressure of intake air, atmospheric pressure, oil temperature, etc.) corresponding to the operation environment of the driving source is executed. The change in the control amount according to the operation environment of the driving source is performed after the change in the control amount by the control unit executing the vibration-damping control such as the sprung vibration-damping control unit, and performed to the control amount immediately before the control command is outputted.

Although not described in the above-mentioned embodiment, an idle assist control unit may be provided as the vehicle behavior control unit. The idle assist control is a control for changing the driving force in order that the revolution of the driving source can keep the idle speed, so as to change the behavior of the vehicle 10 during the idle of the driving source. The change in the control amount by the idle assist control unit is performed before the change in the control amount by the sprung vibration-damping control unit.

### INDUSTRIAL APPLICABILITY

As described above, the driving force controlling apparatus and the control method of the driving force controlling apparatus according to the present invention can execute an appropriate vibration-damping control according to a driving condition of a vehicle, and the present invention is well adaptable to various driving force controlling apparatuses that control a driving force of a vehicle so as to suppress a vibration of a vehicle body, and a control method of the driving force controlling apparatus.

1. A driving force controlling apparatus that controls a driving force generated by a driving source based upon a control amount, comprising:
a sprung vibration-damping control unit that changes a control amount, which is calculated according to a requested value based upon at least either one of an accelerator operation by a driver and a running state of a vehicle, to a value by which the driving source can generate the driving force that suppresses a sprung vibration of the vehicle; and
a high-frequency vibration-damping control unit that changes the control amount changed by the sprung vibration-damping control unit to a value by which the driving source can generate the driving force that suppresses a vibration having a frequency component higher than that of the sprung vibration of the vehicle suppressed by the sprung vibration-damping control unit, wherein
the sprung vibration-damping control unit performs the change before the high-frequency component vibration-damping control unit changes the control amount.

2. The driving force controlling apparatus according to claim 1, wherein the high-frequency vibration-damping control unit includes a first high-frequency vibration-damping control unit that suppresses a vibration generated on a power transmission path from the driving source to a driving wheel.

3. The driving force controlling apparatus according to claim 1, wherein the high-frequency vibration-damping control unit includes a second high-frequency vibration-damping control unit that suppresses a vibration generated on the driving source.

4. The driving force controlling apparatus according to claim 1, further comprising:
a vehicle behavior control unit that changes the control amount to a value by which the driving source can generate the driving force that changes the behavior of the vehicle for control, wherein
the sprung vibration-damping control unit performs the change after the vehicle behavior control unit performs the change.

5. The driving force controlling apparatus according to claim 4, wherein the vehicle behavior control unit includes a slowing-down control that regulates a slope of a change in the driving force.

6. A driving force controlling apparatus that controls a driving force generated by a driving source, comprising:
a sprung vibration-damping control unit that performs a change to the driving force to generate a wheel torque with a variation of the driving force, the wheel torque reducing the variation in the wheel speed generating a vibration of 1 to 4 Hz to the vehicle; and
a high-frequency vibration-damping control unit that performs a change to the driving force to suppress a vibration that is generated on the vehicle and has a frequency component higher than 1 to 4 Hz, wherein
the sprung vibration-damping control unit performs the change before the high-frequency vibration-damping control unit performs the change.

7. A control method of a driving force controlling apparatus that controls a driving force generated by a driving source based upon a control amount, the method comprising:
a step of changing a control amount, which is calculated according to a requested value based upon either one of an accelerator operation by a driver and a running state of a vehicle, to a value by which the driving source can generate the driving force that suppresses a sprung vibration of the vehicle; and
a step of changing the changed control amount to a value by which the driving source can generate the driving force that suppresses a vibration having a frequency component higher than that of the sprung vibration of the vehicle.
